(19) United States
(12) Patent Application Publication
(10) Pub. No.: US 2020/0134096 A1
(43) Pub. Date: Apr. 30, 2020

(54) SEARCH RESULTS BASED ON MODELS DERIVED FROM DOCUMENTS

(71) Applicant: LONGSAND LIMITED, Cambridge (GB)

(72) Inventors: Sean Blanchflower, Cambridge (GB); Brian Cowe, Cambridge (GB)

(21) Appl. No.: 16/174,916

(22) Filed: Oct. 30, 2018

(51) Int. Cl. G06F 17/30

(52) U.S. Cl. CPC G06F 17/30867; G06F 17/3053; G06F 17/30011

(57) ABSTRACT

In some examples, a system accesses, in response to a search received from a first entity, a model derived from documents produced by the first entity or a group of entities comprising the first entity during operation of the first entity or the group of entities, the model comprising indications of importance of terms extracted from the documents. The system returns a search result that is based on the query and on the model.

### BACKGROUND

Users can perform searches to retrieve information from a data repository (or multiple data repositories). A data repository can include a database, such as a structured database that is accessed using Structured Query Language (SQL) queries, or a non-structured database. A data repository can be available on a network, such as the Internet, a private network, and so forth.

### BRIEF DESCRIPTION OF THE DRAWINGS

Some implementations of the present disclosure are described with respect to the following figures.

FIG. 1 is a block diagram of an arrangement according to some examples.

FIG. 2 is a flow diagram of the process according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Search results returned in response to a query submitted to obtain information from a data repository can be based on identification of the search results based on terms included in the query (a term in a query can be referred to as a “search term”). A “term” can refer to a word, a phrase, or any other information that makes up a predicate that indicates what information in the data repository is relevant to the query. For example, a search engine can respond to the query by identifying data records in the data repository that contain terms satisfying (e.g., matching exactly, matching partially, etc.) the search term(s) of the query.

Different users that submit the same search terms in respective queries may expect different results. For example, a member of a finance group of an enterprise seeking information regarding about “tablet computers” (an example of a search term) may seek data records that are different from the data records sought by a member of a technical research and development group of the enterprise using the same search term. The member of the finance group may be interested in documents relating to sales and revenue of tablet computers, while the member of the technical research and development group may be interested in documents relating to recent advancements in technical features of electronic component in tablet computers.

Returning the same collection of documents based on a query containing a given search term regardless of which user submitted the query may produce search results that are not satisfactory for at least some users.

In accordance with some implementations of the present disclosure, documents produced by users (or groups of users) are used to derive models that include terms and respective indications of importance of the terms. A document “produced” by a user or group of users can refer to a document that is created by the user or group, modified by the user or group, or a document having content to which the user or group made a contribution. The models derived based on the documents produced by users or groups of users can be used to identify search results that are more tailored towards interests of users that submit queries for information.

The documents produced by users or groups of users contain terms that are of interest in the day-to-day activities of the users or groups of users. When such terms are considered in performing searches, the likelihood of providing search results more tailored to the interests of the users that submit queries is increased.

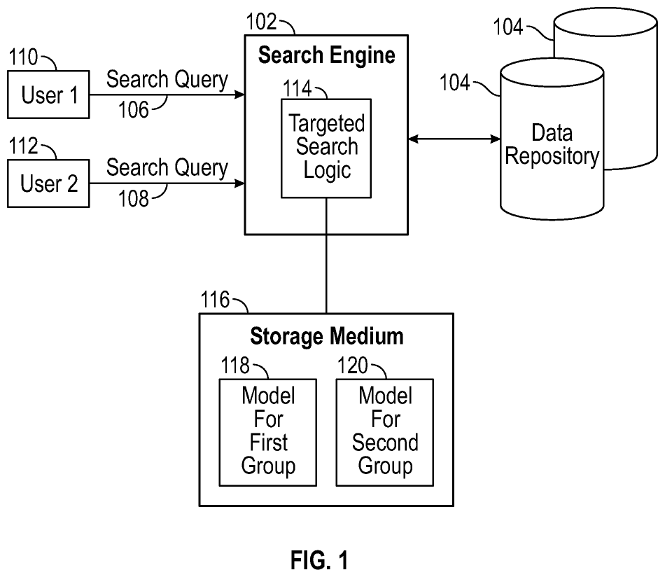

FIG. 1 illustrates an example arrangement that includes a search engine 102, which is to perform searches of a data repository 104 (or of multiple data repositories) in response to search queries (e.g., 106, 108) received from respective users 110 and 112.

As used here, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

A data repository 104 can refer to a structured database, such as a database that is accessed using Structured Query Language (SQL) queries. A structured database can store data in relational tables. Alternatively, a data repository can refer to a non-structured database, which stores data in an unstructured manner. In other examples, a data repository can refer to any other collection of information that can be searched by the search engine 102.

Although FIG. 1 shows an example where there is just one search engine, it is noted that in other examples, there can be multiple search engines to search the data repositories 104.

A user can use an electronic device to submit a respective search query to the search engine 102. Examples of electronic devices include desktop computers, notebook computers, tablet computers, smartphones, and so forth. Thus, in an example of FIG. 1, the first user 110 can use a first electronic device to submit the search query 106 to the search engine 102, and the second user 112 can use a second electronic device to submit the search query 108 to the search engine 102.

The search engine 102 includes targeted search logic 114 according to some implementations of the present disclosure, where the targeted search logic 114 performs a targeted search of data in the data repository 104 using a model that is derived from documents produced by a particular user or a particular group of users.

The targeted search logic 114 can include a portion of the hardware processing circuit of the search engine 102, or alternatively, the targeted search logic 114 can be implemented as machine-readable instructions executable by the search engine 102. In other examples, the targeted search logic 114 can be separate from the search engine 102.

As depicted in FIG. 1, a storage medium 116 stores various models 118 and 120 derived from documents associated with respective different groups. The storage medium 116 can include a storage device (or multiple storage devices) and/or a memory device (or multiple memory devices). The storage medium 116 can be part of the search engine 102 or can be separate from but accessible by the search engine 102.

The model 118 is derived based on documents produced by a first group of users, where the first group of users can include the first user 110. By using the model 118 when processing the search query 106 from the first user 110, the targeted search logic 114 is able to return search results that are more targeted towards the interest of the first user 110. Similarly, the model 120 is derived based on documents produced by a second group of users, where the second group of users include the second user 112.

Although FIG. 1 shows an example where the model 118 is based on documents produced by the first group of users, it is noted that in other examples, the model 118 can be based on documents produced by the first user 110. Similarly, the model 120 can be based on documents produced by the second group of users or by just the second user 112.

Moreover, although the foregoing examples refer to users submitting search queries to the search engine 102 and models based on documents produced by users or groups of users, it is noted that in other examples, other types of entitles can submit search queries to the search engine 102. Such other types of entities can include machines or programs.

Also, generally, a model used by the targeted search logic 114 can be based on documents produced by an entity or a group of entities, where an entity can refer to any of a user, a machine, or a program.

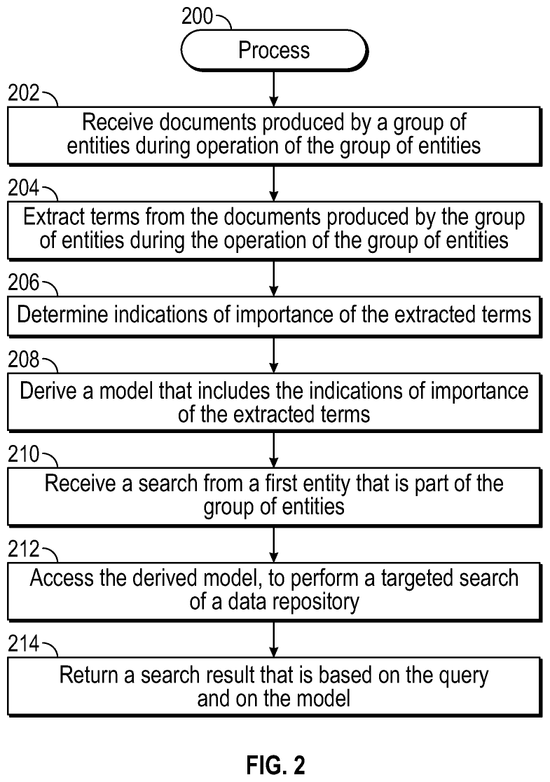

FIG. 2 is a flow diagram of a process 200 that can be performed by the targeted search logic 114 according to some examples. Although FIG. 2 shows a specific order of tasks, it is noted that in other examples, the tasks of the process 200 may be performed in a different order, or the tasks can be replaced with other tasks, or more tasks can be part of the process 200.

In the example of FIG. 2, it is assumed that the targeted search logic 114 performs both the derivation of models (e.g., 118, 120 in FIG. 1) used for performing targeted search, as well as performs processing of search queries received from entities. In other examples, the targeted search logic 114 of FIG. 1 can perform the targeted search using models generated based on documents produced by entities or groups of entities, while a different logic (which can be part of the search engine 102 or part of a different controller) can perform the generation of the models used for the targeted search.

The process 200 receives (at 202) documents produced by a group of entities during operation of the group of entities. As used here, an “operation” of a group of entities refers to an activity (or collection of activities) of a group of entities in performing tasks. The group of entities can collaborate with one another during the operation to collaboratively produce the documents, such as to collaboratively create documents, modify documents, or otherwise make contributions to the content of documents. In examples where the entities are users, a group of users can belong to a department of an enterprise, such as a business concern, an educational organization, a government agency, and so forth. In other examples, other groups of users can be defined. As part of the work of the users, the users can collaborate to produce documents. Examples of documents that can be produced by users include emails, word processing documents, presentations, spreadsheets, summary reports, and so forth.

The process 200 extracts (at 204) terms from the documents produced by the group of entities during the operation of the group of entities. As used here, a “term” can refer to a word, a portion of a word, a phrase that includes multiple words, and so forth. The terms that are extracted can exclude terms that are common terms. For example, words such as “the,” “and,” and so forth are common terms that do not meaningfully aid in producing targeted search results. Such common terms can be referred to as “stop terms,” which are terms that occur with a frequency in documents that is deemed to exceed some frequency threshold.

The process 200 determines (at 206) indications of importance of the extracted terms. The indications of importance can be represented by weights or any other values that provide some indication of the relative importance of an extracted term relative to other extracted terms. In some examples, the indications of importance can be based on a metric produced using a term frequency-inverse document frequency (TF-IDF) technique. In other examples, other term-weighting techniques can be employed.

The weighting factor of the TF-IDF technique is in the form of a TF-IDF value that increases proportionally to the number of times a word appears in a document and is offset (decreased) by the number of documents in a corpus of documents that contain the term. The term frequency (TF) is based on the number of times a term occurs within a document. Thus, a term that occurs more frequently in a document would have a larger TF value. The inverse document frequency (IDF) is based on the number of times the term appears in a corpus of documents. If a term appears in a larger number of documents, then the IDF is large. A larger IDF value offsets the TF value—consequently, a greater frequency of a term in the corpus of documents reduces the overall weighting factor calculated for the term.

The process 200 derives (at 208) a model that includes the indications of importance of the extracted terms. For example, the derived model can include a list of terms and the corresponding indications of importance of the listed terms. In other examples, the model can have a different form.

By using the model derived according to some implementations of the present disclosure, terms that are focused upon by a given group of entities can be identified with greater indications of importance. For example, jargon or domain-specific terms that are used by a group of entities may be terms of particular interest to the group of entities. Members of a finance group may employ different domain-specific terms and jargon as compared to members of a technical research and development group.

The process 200 further receives (at 210) a search from a first entity that is part of the group of entities. In response to the search, the process 200 accesses (at 212) the derived model, to perform a targeted search of a data repository (e.g., 104 in FIG. 1). The process 200 returns (at 214) a search result that is based on the query and on the model.

In performing the targeted search, the targeted search logic 114 determines whether data records of the data repository contain terms that match the terms included in the derived model. If so, the targeted search logic 114 retrieves the respective indications of importance of the terms that match the terms included in the derived model. The indications of importance can be used by the targeted search logic 114 to decide which data records are of higher relevance to the search query. For example, a data record that contains many occurrences of a particular term that is associated with a relatively high indication of importance in the derived model can be identified as being more relevant than another data record that does not contain the particular term or that has a smaller number of occurrences of the particular term.

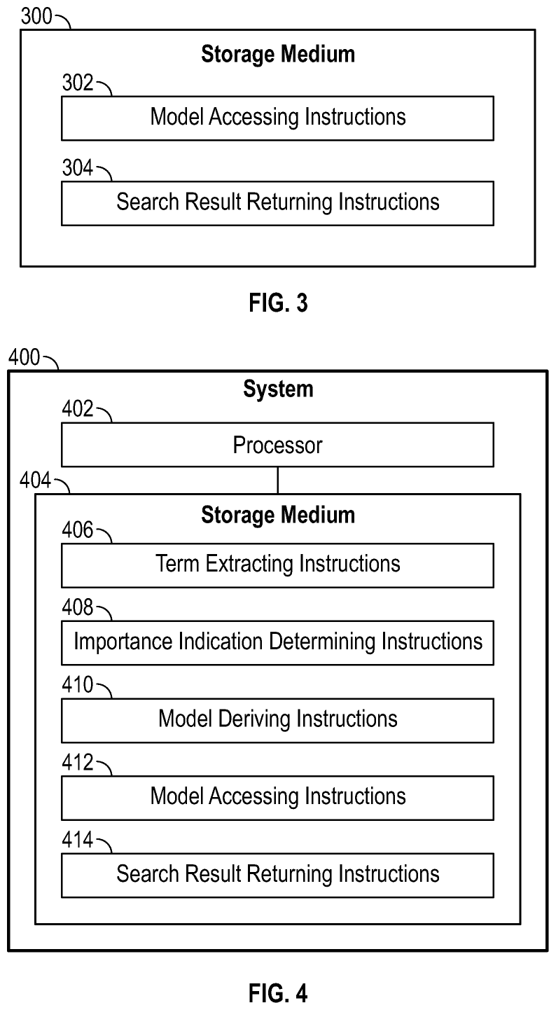

FIG. 3 is a block diagram of a non-transitory machine-readable or computer-readable storage medium 300 storing machine-readable instructions that upon execution cause a system (e.g., the search engine 102 or a different system) to perform various tasks.

The machine-readable instructions include model accessing instructions 302 to, in response to a search received from a first entity, access a model derived from documents produced by the first entity or a group of entities comprising the first entity during operation of the first entity or the group of entities, the model comprising indications of importance of terms extracted from the documents.

In some examples, the model is derived from documents produced by the group of entities that collaborate with one another. For example, the group of entities can be part of an enterprise that provides a product or a service. The terms of the model can include jargon words or phrases used by the first entity or the group of entities. As another example, the terms of the model can include terms specific to a domain of the group of entities, such as a finance domain, research and development domain, sales domain, product support domain, etc.

To compute the indications of importance for the model, the machine-readable instructions can extract terms from the documents produced by the first entity or the group of entities during operation of the first entity or the group of entities, count respective numbers of occurrences of the extracted terms (such as numbers of occurrences of the extracted terms in a document or a corpus of documents for driving TF and IDF values as explained above), compute the indications of importance for the extracted terms based on the respective numbers of occurrences of the extracted terms.

The machine-readable instructions further include search result returning instructions 304 to return a search result that is based on the query and on the model.

FIG. 4 is a block diagram of a system 400 that includes a hardware processor 402 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 400 further includes a storage medium 404 that stores machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions include term extracting instructions 406 to extract terms from documents produced by a group of entities during operation of the group of entities. The machine-readable instructions further include importance indication determining instructions 408 to determine indications of importance of the extracted terms. The machine-readable instructions further include model deriving instructions 410 to derive a model comprising the indications of importance of the extracted terms. For example, the model can include a list of terms and the associated indications of importance (e.g., weights). In further examples, the model can further include information associated with individual entities (e.g., user identifiers or identifiers of other entities, location information of entities, etc.) and information associated with the group of entities (e.g., group identifiers, location information of a group, etc.).

The machine-readable instructions also include model accessing instructions 412 to, in response to a search received from a first entity that is part of the group of entities, access the model. The machine-readable instructions further include search result returning instructions 414 to return a search result that is based on the query and on the model.

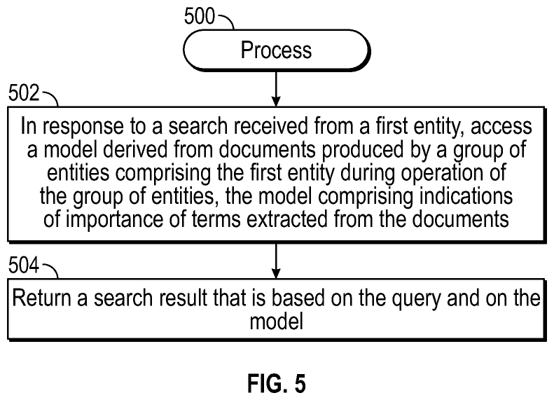

FIG. 5 is a flow diagram of a process 500 performed by a system comprising a hardware processor. The process 500 includes, in response to a search received from a first entity, accessing (at 502) a model derived from documents produced by a group of entities comprising the first entity during operation of the group of entities, the model comprising indications of importance of terms extracted from the documents. The process 500 further includes returning (at 504) a search result that is based on the query and on the model.

The storage medium 300 (FIG. 3) or 404 (FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
in response to a search received from a first entity, access a model derived from documents produced by the first entity or a group of entities comprising the first entity during operation of the first entity or the group of entities, the model comprising indications of importance of terms extracted from the documents; and
return a search result that is based on the query and on the model.

2. The non-transitory machine-readable storage medium of claim 1, wherein the model is derived from documents produced by the group of entities that collaborate with one another.

3. The non-transitory machine-readable storage medium of claim 2, wherein the group of entities are part of an enterprise that provides a product or a service.

4. The non-transitory machine-readable storage medium of claim 1, wherein the terms comprise jargon words or phrases used by the first entity or the group of entities.

5. The non-transitory machine-readable storage medium of claim 1, wherein the terms comprise terms specific to a domain of the group of entities.

6. The non-transitory machine-readable storage medium of claim 1, wherein the indications of importance of terms in the model comprises weights, and wherein the instructions upon execution cause the system to:
identify search results that are relevant for the query; and
select the returned search result from the identified search results based on the weights.

7. The non-transitory machine-readable storage medium of claim 6, wherein selecting the returned search result from the identified search results comprises determining presence of given terms of the model in the identified search results, and the weights assigned the given terms in the model.

8. The non-transitory machine-readable storage medium of claim 1, wherein the instructions upon execution cause the system to:
extract terms from the documents produced by the first entity or the group of entities during operation of the first entity or the group of entities;
count respective numbers of occurrences of the extracted terms; and
compute the indications of importance for the extracted terms based on the respective numbers of occurrences of the extracted terms.

9. The non-transitory machine-readable storage medium of claim 8, wherein the instructions upon execution cause the system to:
derive the model that comprises the extracted terms and the computed indications of importance for the extracted terms.

10. The non-transitory machine-readable storage medium of claim 8, wherein the instructions upon execution cause the system to:
identify terms that occur with a frequency in the documents exceeding a frequency threshold; and
exclude the identified terms from the extracted terms.

11. A system comprising:
a processor; and
a non-transitory storage medium storing instructions executable on the processor to:
extract terms from documents produced by a group of entities during operation of the group of entities;
determine indications of importance of the extracted terms;
derive a model comprising the indications of importance of the extracted terms;
in response to a search received from a first entity that is part of the group of entities, access the model; and
return a search result that is based on the query and on the model.

12. The system of claim 11, wherein the instructions are executable on the processor to:
include the extracted terms and the indications of importance of the extracted terms in the model.

13. The system of claim 11, wherein the instructions are executable on the processor to:
identify search results that are relevant for the query; and
select the returned search result from the identified search results based on the indications of importance.

14. The system of claim 13, wherein the instructions are executable on the processor to:
select the returned search result from the identified search results by determining presence of given terms of the model in the identified search results, and the indications of importance assigned the given terms in the model.

15. The system of claim 11, wherein the instructions are executable on the processor to:
count respective numbers of occurrences of the extracted terms; and
compute the indications of importance for the extracted terms based on the respective numbers of occurrences of the extracted terms.

16. The system of claim 11, wherein the documents are produced by the group of entities based on collaboration among entities of the group of entities.

17. The system of claim 11, wherein the instructions are executable on the processor to:
derive the model that further comprises information associated with individual entities of the group of entities and information associated with the group of entities.

18. The system of claim 17, wherein the information associated with the individual entities of the group of entities comprises identifiers and location information of the individual entities, and the information associated with the group of entities comprises a group identifier and location information of the group of entities.

19. A method performed by a system comprising a hardware processor, comprising:
in response to a search received from a first entity, accessing a model derived from documents produced by a group of entities comprising the first entity during operation of the group of entities, the model comprising indications of importance of terms extracted from the documents; and
returning a search result that is based on the query and on the model.

20. The method of claim 19, further comprising:
extracting terms from the documents produced by the group of entities during operation of the group of entities;
counting respective numbers of occurrences of the extracted terms; and
computing the indications of importance for the extracted terms based on the respective numbers of occurrences of the extracted terms.
